(19) United States
(12) Patent Application Publication
(10) Pub. No.: US 2018/0137546 A1
(43) Pub. Date: May 17, 2018

(54) SYSTEMS AND METHODS FOR DELIVERING ADVERTISEMENTS

(71) Applicant: SOCIAL NETWORKING TECHNOLOGY, INC., Wichita, KS (US)

(72) Inventor: Taewook KANG, Wichita, KS (US)

(21) Appl. No.: 15/811,795

(22) Filed: Nov. 14, 2017

Related U.S. Application Data
(60) Provisional application No. 62/422,271, filed on Nov. 15, 2016.

(51) Int. Cl. G06Q 30/02; H04L 29/08

(52) U.S. Cl. CPC G06Q 30/0277; H04L 67/146; H04L 67/02

(57) ABSTRACT

Systems and methods for providing advertisements to browsers that block advertisements involve one or more of: (1) domain masking; (2) plaintext coding of advertisements; and (3) advertisement resizing. Domain masking involves using a modified version of the URL of the webpage for an advertisement so that it has a different sub-domain than that of the URL of the webpage. Plaintext coding of the advertisements involves identifying placement of advertisements in different sections of a webpage using identifiers that do not indicate the content being placed is an advertisement. Advertisement resizing involves modifying the size of the advertisement to deviate from standard advertisement sizes.

### BACKGROUND OF THE INVENTION

Exemplary embodiments of the present invention are directed to systems and methods for delivering advertisements to avoid ad-blockers.

As the Internet evolved content producers, including both large corporations and individuals (e.g., bloggers), looked to various ways for compensation for the produced content. Although paywalls requiring a direct payment to the content producer have often been tried as a monetization mechanism, only the largest of content producers, such as the New York Times and Wall Street Journal, have had any success with paywalls.

Consumers want free content, which has led to the rise of advertisements displayed on web pages or in an application. Similar to television and radio advertising, the consumer obtains free content in exchange for viewing advertisements. The advertiser then compensates the content producer for the displayed advertisements.

There are a large number of different types of advertisements, including pop-over advertisements (i.e., the advertisement appears on top of the displayed web page), pop-under advertisements (i.e., the displayed web page obscures the advertisement), banner advertisements (i.e., advertisements displayed at the top of a web page), and advertisements displayed along the side of or intermixed with the content itself.

Content producers often must balance competing interests of the advertisers, who want to ensure consumers view the advertisement, and consumers that may not mind advertisements so long as the advertisements do not overly intrude upon the browsing experience. Consumers also worry about rich media advertisements incorporating video and/or audio due to the amount of processing resources consumed to produce these advertisements, as well as the resulting power usage, which can be a particular concern for battery powered devices.

Advertisement blockers (herein referred to as “ad-blockers”) were developed to address consumer concerns regarding advertisements. Ad-blockers were originally developed as browser plug-ins that reviewed web page code to identify and not reproduce advertisements. Ad-blockers are now being produced that are incorporated directly into browser applications so as to not require the development of a plug-in for each different type of browser (i.e., a different version for Firefox, Chrome, Internet Explorer, Edge, Safari, Opera, etc.).

As ad-blockers have increased in popularity content producers are concerned about their ability to continue to profitably provide content via the Internet due to the loss of advertising revenue from the blocked advertisements. Content producers are also concerned with some ad-blockers that replace the original advertisements with those from the ad-blocker developer because the ad-blocker developer receives revenue from the advertisements displayed along with the content producer's content. Thus, many content producers believe ad-blockers represent a threat to their very existence.

### SUMMARY OF THE INVENTION

Exemplary embodiments of the present invention use one or more of the following techniques to avoid advertisement blocking: (1) domain masking; (2) plaintext coding of advertisements; and (3) advertisement resizing.

Domain masking involves using a modified version of the uniform resource locator (URL) of the webpage for an advertisement so that it has a different sub-domain than that of the URL of the webpage. The modified URL points to a different Internet Protocol (IP) address than the URL of the webpage so that the advertisements can be retrieved without being blocked. Because the webpage URL and the modified URL have the same domain and top-level domain the ad-blocker would see requests for advertisements directed to the modified URL as requests for user-desired content for the webpage instead of as requests for advertisements.

Plaintext coding of the advertisements involves identifying placement of advertisements in different sections of a webpage using identifiers that do not indicate the content being placed is an advertisement. This can be achieved using an HTML <DIV> tag that includes plaintext that does not include a URL or IP address. Thus, an ad-blocker cannot determine the content being inserted into the section of the webpage based on the information in the <DIV> tag.

Advertisement resizing involves modifying the size of the advertisement to deviate from standard advertisement sizes. Most advertisements are designed to conform to specific sizes, such as 300×250 pixels or 250×250 pixels. By modifying the size of an advertisement an ad-blocker cannot block advertisements based on size alone. The resizing can be performed randomly so that an ad-blocker cannot simply be updated with new sizes that are identified as advertisements. The resizing, random or otherwise, can be confined within certain predetermined number of pixels (or any other type of size measurement) of the original advertisement size, such as ±10 pixels. The resizing need not make significant changes to the advertisement size, for example the horizontal or vertical dimension of the advertisement can be adjusted as little as ±1 pixel.

According to an exemplary embodiment a method involves obtaining a first uniform resource locator (URL) for a webpage, wherein the first URL includes a sub-domain portion, a domain portion, and a top-level domain portion and generating a sub-domain for the URL for the webpage. A message is sent to a domain name server (DNS) including a second URL and a second Internet Protocol (IP) address, wherein an IP address for the webpage points to a different server than the second IP address and the first URL and second URL have a same domain and top-level domain but different sub-domains. Code for the webpage is generated that includes a link to an embedded script that populates one or more areas of the webpage with content. A request for the webpage is received and the generated code for the webpage is provided. The generated code is executed to render the webpage by requesting and executing the embedded script linked in the generated code. Execution of the script involves identifying, based on the executed script, one or more advertisement sections of the webpage based on tags in the generated code for the webpage; requesting advertising content for the one or more identified advertisement sections of the webpage; receiving the requested advertising content; randomly modifying a size of the received requested advertising content; and displaying the randomly modified sized received requested advertising content in the one or more advertisement sections.

According to another exemplary embodiment a method involves providing, by a first entity to a content provider, a sub-domain, a first Internet Protocol (IP) address, and an indication of a domain and top-level domain associated with the sub-domain. The content provider sends a message containing the first IP address and a first Uniform Resource Locator (URL) comprised of the sub-domain, domain, and top-level domain to a domain name server (DNS). The content provider includes the first URL in code for a webpage. A URL for the webpage has the same domain and top-level domain as the first URL but a different sub-domain. The URL for the webpage points to an IP address of one or more servers operated by the content provider and the first IP address points to one or more servers operated by an advertisement provider.

According to a further exemplary embodiment a method involves generating code for a webpage identifying content for the webpage, generating code for the webpage identifying a script, and generating code for the webpage identifying a section of the webpage. The script includes code to render advertising content in the identified section of the webpage and the code identifying the section of the webpage does not contain a Uniform Resource Locator (URL) and does not contain an Internet Protocol (IP) address. The generated code is stored on a server and the generated code is provided to a browser in response to a request from the browser for the webpage.

According to another exemplary embodiment a method involves a browser receiving a first Uniform Resource Locator (URL). The browser sends a request for a first Internet Protocol (IP) address associated with the first URL to a Domain Name Server (DNS) and receives the first IP address. The browser sends a request for a webpage corresponding to the first URL to a first server and receives code for the webpage. The browser renders the received code by obtaining content from the first server and rendering the content on the webpage; obtaining a script from a second server; obtaining advertising content by executing the script; randomly resizing the obtained advertising content based on the executed script; and displaying the webpage including the rendered content and the randomly resized advertising content.

### BRIEF DESCRIPTION OF THE DRAWING FIGURES

FIG. 1 is a block diagram of an exemplary web page in accordance with the present invention;

FIG. 2 is a block diagram of an exemplary computer in accordance with the present invention; and

FIGS. 3A and 3B are ladder diagrams of an exemplary method for delivering advertisements in accordance with the present invention.

### DETAILED DESCRIPTION

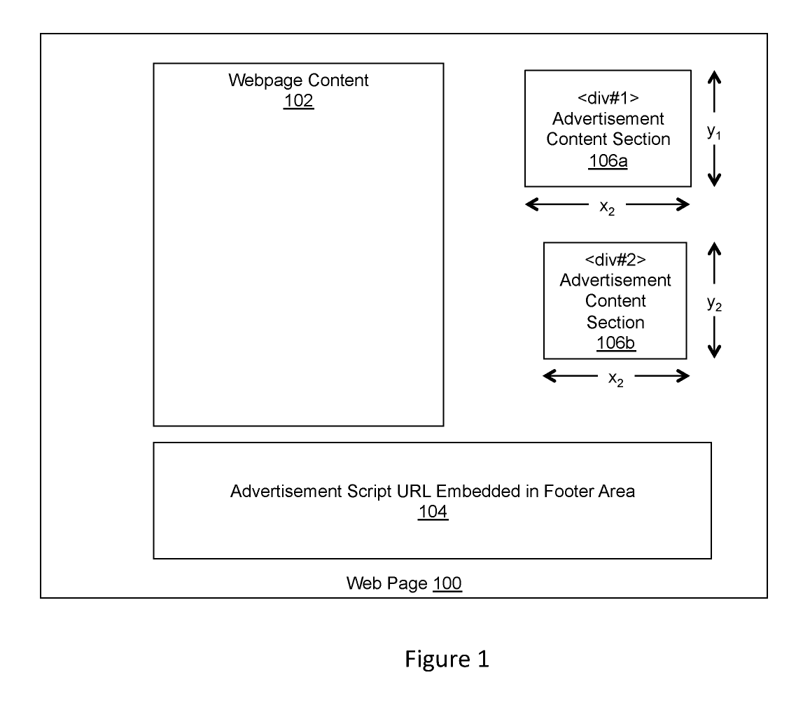

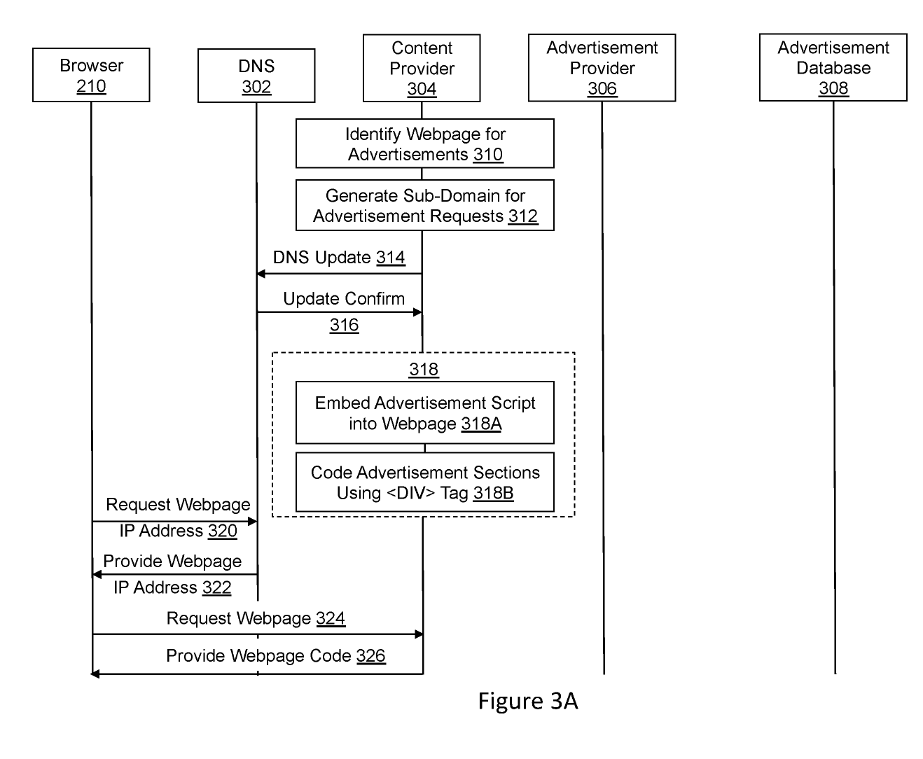

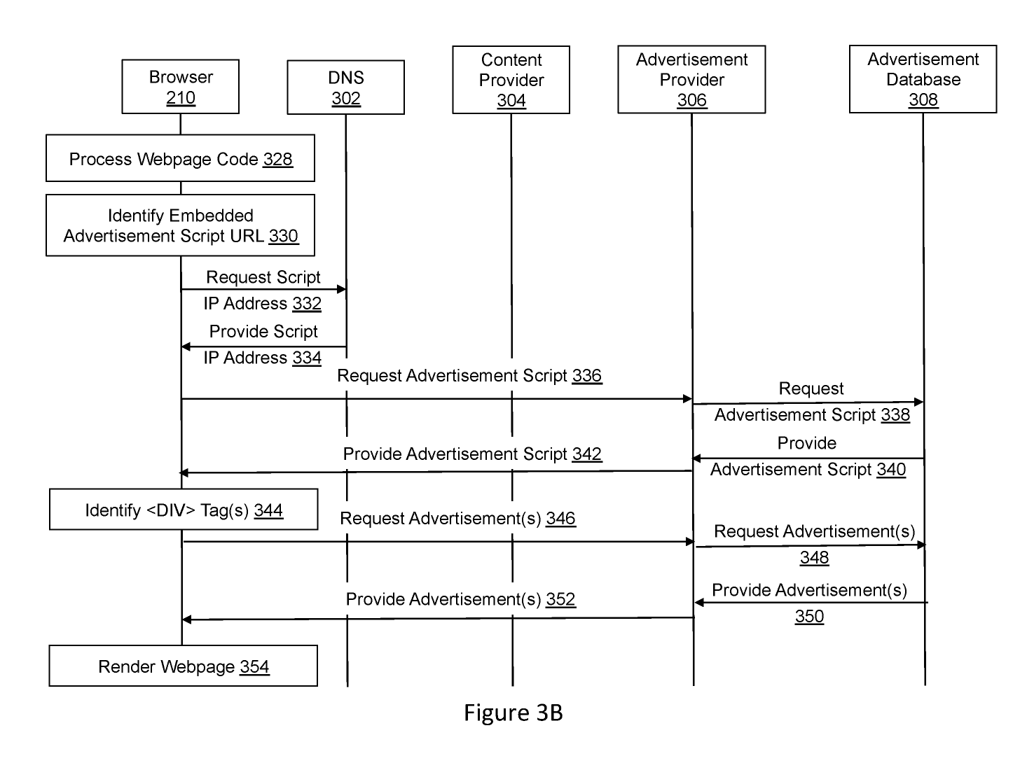

Exemplary embodiments are directed to systems and methods for delivering content and/or advertisements relevant to other content on a web page. Specifically, referring to FIG. 1, a web page 100 has a content section 102, which can include, among other things, news articles or other information. The webpage also includes an advertisement script uniform resource locator (URL) embedded in the footer area 104 and advertisement content sections 106a and 106b. The advertisement script URL is directed to an advertisement server from which the advertisement script itself is obtained. In order to avoid an ad-blocker blocking the browser from downloading the advertisement script the URL is a masked URL that appears similar to the webpage URL but is directed to an advertisement server instead of the content server. For example, if the URL of the content server is www.news.com the sub-domain portion of the URL is changed for the advertisement script, such as xyz.news.com (i.e.,“www” and “xyz” are the sub-domain portion). Those skilled in the art will recognize the middle part of the URL (i.e., “news”) is the domain and the end part of the URL (i.e., “.com”) is the top-level domain. Because web sites often employ the sub-domain for various purposes that still point back to the content server, an ad-blocker will not be able to distinguish between a request directed to the content server and a request to the advertisement server. The details of the domain masking are described below in connection with FIG. 3A.

As indicated in FIG. 1, the advertisement content sections 106a and 106b are encoded in the web page code using <DIV> tags, which are conventional HTML tags used to identify the formatting of particular sections of a webpage. These content sections can be encoded with generic names that do not contain a URL or Internet Protocol (IP) address because the embedded advertisement script will be coded to recognize these generic names and can place the advertisements in these sections. In contrast to advertisements encoded with a URL from which to obtain the advertisements, the use of generic names prevents ad-blockers being able to identify these content sections as advertisement sections.

FIG. 1 also indicates the size of advertisement content sections 106a and 106b are different, i.e., content section 106a is x₁ pixels by y₁ pixels and content section 106b is x₂ pixels by y₂ pixels. Because advertising content is typically designed to have certain sizes (e.g., 300×250, 250×250, etc.) these different sizes are intended to deviate from these typical sizes so that an ad-blocker cannot block the advertisement being placed in this area based on size alone. The different sizes can be random to prevent ad-blockers from being programmed to recognize these newly-defined, non-standard sizes. To prevent the random sizes from affecting the overall look and feel of the webpage the random sizes can be constrained within a certain range of the original size, such as ±10 pixels of an original size of the advertisement. The changes in size can be different for the vertical and horizontal dimensions and can be as little as 1 pixel different from the original size. The size difference between advertisement content sections 106a and 106b are exaggerated for purposes of illustration and the size difference can be much smaller, such as just a single pixel in either the x or y dimension.

The arrangement of webpage elements in FIG. 1 is merely exemplary and the present invention can be implemented with different arrangements, including advertisements intermixed with content, banner advertisements at the top of the page, etc. Further, if the advertisements are implemented as pop-over or pop-under advertisements that are coded directly in the script, then the use of <DIV> tags for placing advertisements can be omitted. Although FIG. 1 illustrates the advertisement script URL being embedded in the footer area of the webpage, the advertisement script URL can be embedded anywhere on the page, including the header area.

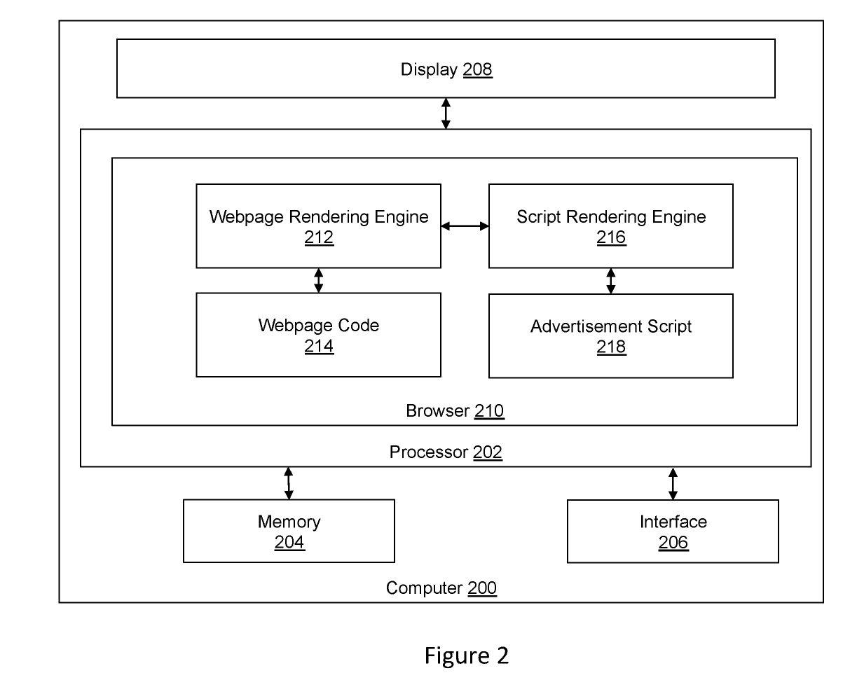

FIG. 2 is a block diagram of an exemplary computer 200 in accordance with the present invention. The present invention can be implemented on any type of device capable of reproducing web pages, and thus the term computer should be understood as including any device having such a capability, including desktop computers, laptop computers, smart phones, tablets, wearable computers, smart watches, and the like. Computer 200 includes one or more interfaces 206 for communicating with Internet servers, which can be any type of wireless and/or wired interface. Interface 206 is coupled to processor 202, which is coupled to one or more memories 204 in order to execute applications and render/reproduce web pages. Processor 202 can be any type of processor, including a microprocessor, field programmable gate array (FPGA), application specific integrated circuit (ASIC), and/or the like. Memory 204 can include any type of memory, including random access memory (RAM), read-only memory (ROM), a solid state hard drive (SSD), a spinning hard drive, and/or the like. Further, some of the memory 204 can be external to the computer 200.

Using computer code loaded from memory 204, processor 202 executes browser 210. Browser 210 includes a web page rendering engine 212, which executes web page code 214, typically in the form of HTML, obtained from a web page server. Browser 210 may also include one or more script rendering engines 216, which can execute, among other things, an advertisement script 218. When the advertisement script is implemented using native browser code, such as HTML and/or CSS, script rendering engine 216 can be part of web page rendering engine 212 and advertisement script 218 can be part of web page code 214. When the advertisement is implemented using non-native code of the browser, such as by using a plug-in, advertisement script 218 can be in the plug-in native code and script rendering engine 216 can be a plug-in engine, such as Oracle's Java, Adobe's Flash, Apple's QuickTime player, and/or the like. Thus, processor 202, using browser 210, provides a rendered web page, including any rendered plug-ins, to display 208 as an output for a user. Although display 208 is illustrated as being part of computer 200, the display can be an external component, depending upon the type of computer.

Exemplary embodiments of the present invention employ one or more of the following techniques to avoid advertisement blocking: (1) domain masking; (2) plaintext coding of advertisements; and (3) advertisement resizing, which will be described in connection with the ladder diagrams in FIGS. 3A and 3B. These techniques involve one or more of browser 210, domain name server (DNS) 302, content provider 304, advertisement provider 306, and advertisement database 308. Depending upon implementation advertisement database 308 can be on the same server as the server for advertisement provider 306 or on a different server.

A DNS 302 is one of a number of servers in the Internet used to resolve a URL to an Internet protocol address, such as from www.news.com to 8.1.8.8. The Internet has many DNS servers (although currently only 13 root servers) and accordingly the DNS used for one message exchange in the method below need not be the same as another message exchange.

A content provider 304 is an entity operating a website providing any type of content. The content provider can operate one or more content servers to provide the content, which can be accessed via the same or different URLs and/or IP addresses. The content provider can be any size, from a large organization (e.g., a newspaper, magazine, television station, radio station, etc.) to a single person, such as a blogger. FIGS. 3A and 3B illustrate the content provider instead of one of its servers because the content provider server used for one message exchange can be different than the content provider server used for another message exchange.

An advertisement provider is an entity operating one or more servers providing advertisements obtained from a database, such as advertisement database 308. An advertisement provider can operate an advertising network connecting advertisers to web sites hosting advertisements. Although there are some content providers that also operate their own advertising networks (e.g., Google), most content providers rely on third-party advertising networks as part of their business model. Thus, the content provider and the advertisement provider can be different entities that operate different server(s). FIGS. 3A and 3B illustrate the advertisement provider instead of one of its servers because the advertisement provider server used for one message exchange can be different than the advertisement provider server used for another message exchange.

Initially, a content provider identifies webpages that are to carry advertisements (step 310) and then generates a sub-domain for the advertisement requests that differs from the sub-domain of the identified webpages (step 312). Depending upon implementation a third-party (e.g., the advertisement provider) can generate the sub-domain for the content provider 304. Because content provider 304 is the owner of the domain carrying the webpages and thus the domain with the generated sub-domain, new associations between URLs and IP addresses will only be accepted by a DNS from content provider 304. If, however, another party owns, operates, or otherwise manages the domain on behalf of content provider 304 this party will be the one authorized to provide new associations to DNS 302. Regardless, content provider 304 or any other authorized entity sends a DNS update message (step 314) with the association of the generated sub-domain with an IP address of a server operated by advertisement provider 306 to DNS 302, which responds with a message confirming the update (step 316). Once the association is updated in one DNS it is propagated to all of the others using known techniques so that the generated sub-domain will resolve to an IP address of a server operated by advertisement provider 306 regardless of which DNS is accessed by browser 210.

Content provider 304 then inserts code for the advertisements in the webpage code (step 318). Specifically, content provider 304 inserts the advertisement script URL having the generated sub-domain (step 318A) and the <DIV> tags defining the sections that will contain the advertisements (step 318B). The embedded advertisement script URL can be coded as, for example, <script src=“xyz.news.com”></script>. The <DIV> tags can be coded as, for example, <div id=“News-Home-Zone-1”></div> and <div id=“News-Home-Zone-2”></div>. Of course, other identifiers can be used for the different <DIV> sections and the encoding of the embedded advertisement script URL will depend on the generated sub-domain and the domain and top-level domain for the particular website.

Step 318 assumes the code for the remainder of the webpage has already been generated. For example, the content provider may use a template for webpages that dynamically pulls various content and advertisements into the rendered webpage. This template can include sections defined for advertisements, which can then be replaced by the <DIV> tags with the names used by the advertisement script to place advertisements in these sections. If code for the webpage does not exist the code for the remainder of the webpage can be created as part of the embedding of the advertisement script and <DIV> tags.

Now that the domain masking has been setup browser 210 can obtain a webpage having advertisements bypassing an ad-blocker. Specifically, browser 210 sends a webpage request with a URL for the webpage containing the desired content to DNS 302 (step 320), which responds with the IP address for the webpage (step 322). Browser 210 then sends a webpage request to the returned IP address, which in this example is sent to content provider 304 (step 324), which returns the code for the requested webpage (step 326).

Turning now to FIG. 3B, browser 210 processes the received webpage code (step 328). Specifically, web page rendering engine 212 processes the code to obtain content from content provider 304 (which for sake of clarity is not illustrated). Webpage rendering engine 212 identifies the embedded advertisement script URL (step 330) and sends a request containing the URL to DNS 302 (step 332), which responds with the IP address from which the script will be obtained (step 334). As discussed above, the embedded advertisement script URL is the masked domain name having the same domain and top-level domain portions as the content providers URL but with a different sub-domain portion.

Webpage rendering engine 212 then sends a request for the script to the returned IP address, which in this example is a server of advertisement provider 306 (step 336). A server of advertisement provider 306 sends a request for the script to advertisement database 308 (step 338), which provides the script (step 340). The server of advertisement provider 306 then returns the script to browser 210 (step 342).

Script rendering engine 216 of browser 210 processes the provided script and identifies the <DIV> tags that should be filled with content (step 344). Based on the script engine 216 requests one or more advertisements from the server of advertisement provider 306 (step 346), which in turn obtains one or more advertisements from advertisement database 308 (steps 348 and 350). The server of advertisement provider 306 provides the obtained advertisements to script rendering engine 216 (step 352), which then renders the webpage including the content obtained from content provider 305 and the advertisements obtained from advertisement provider 306 (step 354). The rendering can involve randomly modifying the size of the advertisements from their original size. The random modification can result in different random sizes for different advertisements on a webpage and/or can result in one or more of the different advertisements being the same random size, which deviates from the original size of the advertisement(s).

Although the rendering is illustrated as being performed at the end of the method it will be recognized that browser 210 will start rendering the webpage once it has received the webpage code from content provider 304 and the messaging and processing related to the advertisement script and advertisements will occur at the same time as the webpage is rendered.

The request for one or more advertisements by script engine 216 need not, and most likely will not, identifies any particular advertisements. Instead, the selection of advertisements can be dynamic based on various types of information, such as the website being accessed, the content to be displayed on the webpage, and information about the user of browser 210, which can be obtained using cookies.

Exemplary embodiments have been described in connection with providing content and advertisements to a browser for purposes of clarity. It should be recognized, however, the present invention can be employed in any environment in which ad-blocking technology is being employed, such as in connection with in-app advertisements.

Although the messaging has been described above in a generic manner without reference to particular messages and protocols, those skilled in the art would have understood how to implement these messages. For example, the message to request information can be an HTTP GET Request message and the message to provide the requested information can be an HTTP Response message.

The techniques disclosed above can be embodied in a non-transitory computer readable medium, which when executed by a processor causes the processor to perform the disclosed techniques.

Although exemplary embodiments have been described as using all three different advertisement blocking avoidance techniques, the present invention can be implemented using only one or only two of the three techniques. Further, one or more of these techniques can be employed with other types of advertisement blocking avoidance techniques.

Because the present invention is directed to addressing ad-blocking software and browsers, the present invention is necessarily rooted in computer technology that solves problems unique to the Internet.

Although the present invention has been described above by means of embodiments with reference to the enclosed drawings, it is understood that various changes and developments can be implemented without leaving the scope of the present invention, as it is defined in the enclosed claims.

What is claimed is:

1. A method, comprising:
obtaining a first uniform resource locator (URL) for a webpage, wherein the first URL includes a sub-domain portion, a domain portion, and a top-level domain portion;
generating a sub-domain for the URL for the webpage;
sending a message to a domain name server (DNS) including a second URL and a second Internet Protocol (IP) address, wherein an IP address for the webpage points to a different server than the second IP address, and wherein the first URL and second URL have a same domain and top-level domain but different sub-domains;
generating code for the webpage that includes a link to an embedded script that populates one or more areas of the webpage with content;
receiving a request for the webpage;
providing the generated code for the webpage; and
executing the generated code to render the webpage by requesting and executing the embedded script linked in the generated code, wherein execution of the script comprises
identifying, based on the executed script, one or more advertisement sections of the webpage based on tags in the generated code for the webpage;
requesting advertising content for the one or more identified advertisement sections of the webpage;
receiving the requested advertising content;
randomly modifying a size of the received requested advertising content; and
displaying the randomly modified sized received requested advertising content in the one or more advertisement sections.

2. The method of claim 1, wherein the tags are DIV tags.

3. The method of claim 2, wherein the DIV tags do not contain a URL and do not contain an IP address.

4. The method of claim 1, wherein a browser executes the script and the browser requests the advertising content using the second IP address.

5. The method of claim 1, wherein the browser obtains the embedded script using the second URL by
sending the second URL to the DNS;
receiving the second IP address from the DNS; and
sending a request for the embedded script to a server associated with the second IP address.

6. The method of claim 1, wherein the random modification of the size of the received requested advertising content modifies all of the received requested advertising content to a same randomly modified size.

7. The method of claim 1, wherein the random modification of the size of the received requested advertising content modifies different ones of the received requested advertising content to different randomly modified sizes.

8. The method of claim 1, wherein the size of the received requested content is randomly modified within a predetermined size range.

9. The method of claim 8, wherein the predetermined size range is ±10 pixels of an original size of the received requested content.

10. The method of claim 1, wherein the IP address for the webpage points to a content server operated by a first entity and the second IP address points to an advertisement server operated by a second entity.

11. A method comprising:
providing, by a first entity to a content provider, a sub-domain, a first Internet Protocol (IP) address, and an indication of a domain and top-level domain associated with the sub-domain;
sending, by the content provider to a domain name server (DNS), a message containing the first IP address and a first Uniform Resource Locator (URL) comprised of the sub-domain, domain, and top-level domain; and
including, by the content provider, the first URL in code for a webpage, wherein a URL for the webpage has the same domain and top-level domain as the first URL but a different sub-domain,
wherein the URL for the webpage points to an IP address of one or more servers operated by the content provider and the first IP address points to one or more servers operated by an advertisement provider.

12. The method of claim 11, wherein the first URL points to a script, wherein execution of the script involves rendering advertisements in defined sections of the webpage.

13. The method of claim 12, wherein the defined sections are identified by tags in the code for the webpage.

14. The method of claim 13, wherein the tags are DIV tags.

15. The method of claim 12, wherein the tags do not contain a URL or IP address.

16. A method comprising:
generating code for a webpage identifying content for the webpage;
generating code for the webpage identifying a script;
generating code for the webpage identifying a section of the webpage, wherein the script includes code to render advertising content in the identified section of the webpage and the code identifying the section of the webpage does not contain a Uniform Resource Locator (URL) and does not contain an Internet Protocol (IP) address;
storing the generated code on a server; and
providing the generated code to a browser in response to a request from the browser for the webpage.

17. The method of claim 16, wherein the identification of the script includes a URL to another server that is separate and distinct from the server on which the generated code is stored.

18. The method of claim 17, wherein the URL of the script has a same domain and top-level domain as a URL for the webpage but a different sub-domain.

19. The method of claim 17, wherein the URL of the script points to a first IP address and a URL for the webpage points to a second IP address.

20. The method of claim 19, wherein the first IP address points to a server of a content provider and the second IP address points to a server of an advertisement provider.

21. The method of claim 16, wherein the section of the webpage is identified using a <DIV> tag.

22. A method comprising:
receiving, by a browser, a first Uniform Resource Locator (URL);
sending, by the browser to a Domain Name Server (DNS), a request for a first Internet Protocol (IP) address associated with the first URL;
receiving, by the browser, the first IP address;
sending, by the browser to a first server, a request for a webpage corresponding to the first URL;
receiving, by the browser, code for the webpage; and
rendering, by the browser, the received code by
obtaining content from the first server and rendering the content on the webpage;
obtaining a script from a second server;
obtaining advertising content by executing the script;
randomly resizing the obtained advertising content based on the executed script; and
displaying the webpage including the rendered content and the randomly resized advertising content.

23. The method of claim 22, wherein the received code identifies sections of the webpage for the randomly resized advertising content using a tag that does not contain a URL and does not contain an IP address.

24. The method of claim 22, wherein the received code includes a URL for the second server, wherein the first URL and the URL for the second server have a same domain and top-level domain but different sub-domains.

25. The method of claim 22, wherein the first server is operated by a content provider and the second server is part of an advertisement network.

26. The method of claim 22, wherein the random resizing of the received advertising content modifies different ones of the received advertising content to different randomly modified sizes.

27. The method of claim 22, wherein the received advertising content is randomly modified within a predetermined size range.

28. The method of claim 27, wherein the predetermined size range is ±10 pixels of an original size of the received advertising content.
